(19) United States
(12) Patent Application Publication
(10) Pub. No.: US 2024/0165948 A1
(43) Pub. Date: May 23, 2024

(54) RECORDING ELEMENT SUBSTRATE AND RECORDING DEVICE

(71) Applicant: CANON KABUSHIKI KAISHA, Tokyo (JP)

(72) Inventor: HIROYASU NOMURA, Tokyo (JP)

(21) Appl. No.: 18/513,840

(22) Filed: Nov. 20, 2023

(30) Foreign Application Priority Data
Nov. 18, 2022 (JP) 2022-184691

(51) Int. Cl. B41J 2/14; B41J 2/045; B41J 2/05

(52) U.S. Cl. CPC B41J 2/14056; B41J 2/04531; B41J 2/0458; B41J 2/05; B41J 2/14072; B41J 2/14153

(57) ABSTRACT

A recording element substrate includes: a plurality of discharging ports; a plurality of nozzles connected to the plurality of discharging ports respectively; a passage forming portion in which a plurality of individual passages connected to the plurality of nozzles respectively and a common passage connected to the plurality of individual passages are formed; a plurality of supply ports disposed at positions corresponding to a plurality of nozzle groups on the common passage respectively along an array direction of the plurality of discharging ports; and a plurality of supply passages which extend from the plurality of supply ports to a rear surface of the recording element substrate in a direction intersecting with the rear surface. A plurality of heaters configured to heat liquid flowing through the common passage are provided for each of the plurality of supply ports along at least a part of a peripheral edge of the supply port.

### BACKGROUND OF THE INVENTION

### Field of the Invention

The present invention relates to a recording element substrate and a recording device.

### Description of the Related Art

Some inkjet recording devices, which discharge ink through nozzles and allow ink to adhere to a recording medium (e.g., paper), include a heater to apply energy to discharge ink through the nozzles, and a sub-heater to heat the ink before discharging.

For example, in the case of an inkjet recording device according to Japanese Patent Application Publication No. 2010-280213, a long ink supply port is formed on a substrate, and a nozzle array, which is constituted of a plurality of nozzles arranged in an extending direction of the ink supply port, is disposed on both sides of the ink supply port. Further, a heater forming region, where a discharging heater ink for each nozzle is formed is disposed on the outer side of each nozzle array, and a sub-heater is disposed on the outer side of the heater forming region so as to surround three sides of a long rectangular region, including the ink supply port and the heater forming region. Both ends of the sub-heater are connected to a sub-heater power supply terminal, and the sub-heater, to which voltage is applied, heats up to heat the entire substrate, and the ink supplied from the ink supply port is heated. As a result, a drop in the temperature of the ink is suppressed, and the discharge amount fluctuation and discharge failure due to an increase in viscosity are suppressed.

In Japanese Patent Application Publication No. 2010-280213, however, the sub-heater is disposed on the opposite side of the ink supply port with the nozzles therebetween, hence in a case of high print duty recording, where the ink flow rate on the nozzle passage is high, in particular, ink which is not sufficiently heated by the sub-heater may be discharged.

### SUMMARY OF THE INVENTION

The present invention provides a recording element substrate and a recording device equipped with a sub-heater that can heat such liquid as ink more efficiently.

The present invention is a recording element substrate comprising:
a discharging port array which is disposed on a front surface of the recording element substrate, and includes a plurality of discharging ports arrayed in an array direction;
a plurality of nozzles which extend in a direction intersecting with the front surface of the recording element substrate, and are connected to the plurality of discharging ports respectively;
a passage forming portion in which a plurality of individual passages and a common passage are formed, the plurality of individual passages extending in a direction along the front surface of the recording element substrate and being connected to the plurality of nozzles respectively, and the common passage being connected to the plurality of individual passages;
a plurality of supply ports which are disposed on the common passage and are arrayed along the array direction, and are disposed such that, in a case where the plurality of nozzles are divided into a plurality of nozzle groups and each nozzle group includes one or a plurality of nozzles, the plurality of supply ports are disposed at positions corresponding to the plurality of nozzle groups on the common passage respectively; and
a plurality of supply passages which extend from the plurality of supply ports to a rear surface of the recording element substrate in a direction intersecting with the rear surface of the recording element substrate, wherein
a plurality of heaters configured to heat liquid flowing through the common passage are provided for each of the plurality of supply ports along at least a part of a peripheral edge of the supply port.

Further features of the present invention will become apparent from the following description of exemplary embodiments with reference to the attached drawings.

### BRIEF DESCRIPTION OF THE DRAWINGS

FIG. 1 is a plan view depicting a part of a recording element substrate of Embodiment 1;

FIG. 2A is an A-A cross-sectional view of the recording element substrate in FIG. 1;

FIG. 2B is a B-B cross-sectional view of the recording element substrate in FIG. 1;

FIG. 2C is a C-C cross-sectional view of the recording element substrate in FIG. 1;

FIG. 3 is a plan view depicting a part of a recording element substrate of a modification of Embodiment 1;

FIG. 4 is a plan view depicting a part of a recording element substrate of Embodiment 2;

FIG. 5 is a plan view depicting a part of a recording element substrate of Embodiment 3;

FIG. 6 is a plan view depicting a part of a recording element substrate of Embodiment 4; and

FIG. 7A is a view of a recording device of an embodiment, and FIG. 7B is a view of a liquid discharging head thereof.

### DESCRIPTION OF THE EMBODIMENTS

Embodiments of the present invention will be described with reference to the drawings. Embodiments to be described below are examples of embodying the present invention and are not intended to limit the scope of the present invention thereto. Unless otherwise specified, dimensions, shapes, numbers, materials and the like of various members in the following embodiments can be appropriately changed within the scope of the invention.

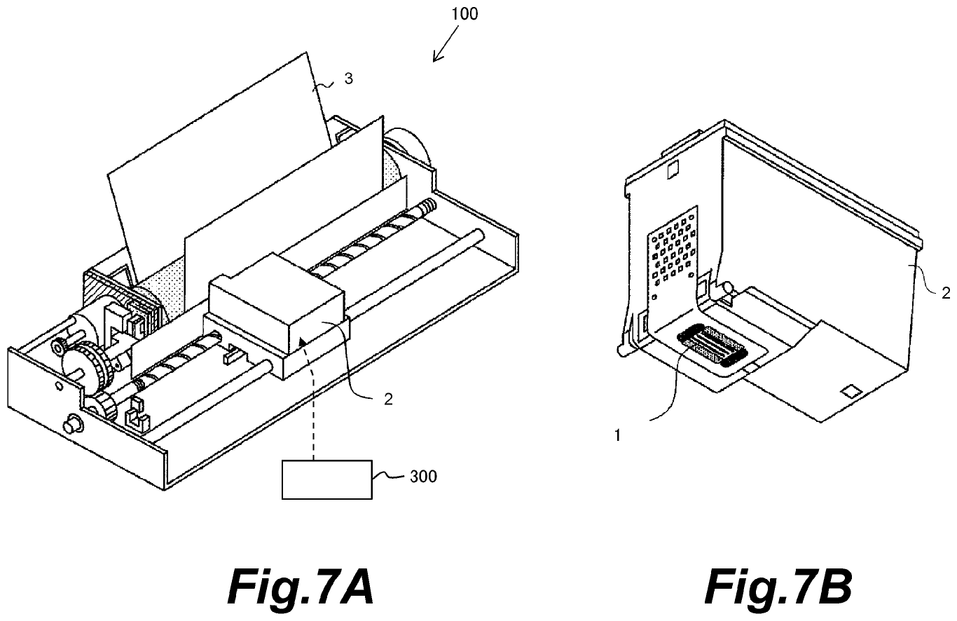

FIGS. 7A and 7B are schematic diagrams depicting a configuration of major portions of a serial type inkjet recording device to which the present invention is applicable. FIG. 7A is a general view depicting a general configuration of the inkjet recording device 100, and FIG. 7B is a perspective view depicting a recording head 2, which is a composing element of the inkjet recording device 100.

In FIGS. 7A and 7B, the recording head 2, which is a liquid discharging head, includes a recording element substrate 1 having a plurality of nozzle arrays each of which is constituted of a plurality of nozzles. The inkjet recording device 100 records an image on a recording medium 3 by discharging ink droplets from discharging ports (not illustrated) corresponding to the nozzles of the recording head 2. The inkjet recording device 100 has a control unit 300 which controls operation of each component constituting the inkjet recording device 100, including the recording element substrate 1 and the recording head 2. The control unit 300 is a computer that includes a CPU, a memory, an input/output unit and the like, and controls the operation of the inkjet recording device 100 based on the image information inputted from the outside and control programs stored in the memory. In particular, the control unit 300 controls the operation of a later mentioned heater and sub-heater, included in the recording element substrate 1.

### Embodiment 1

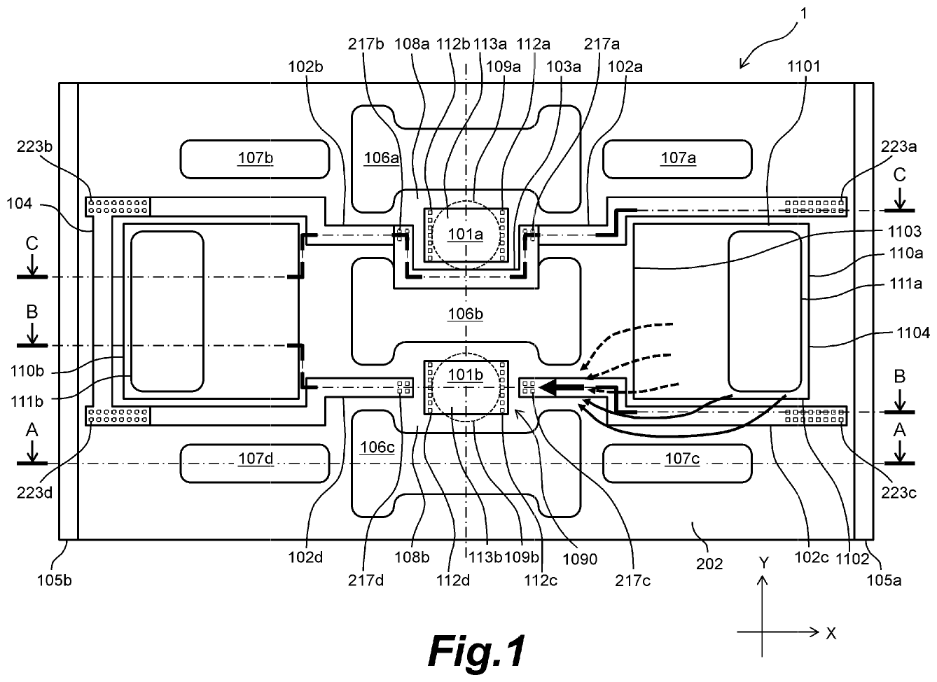

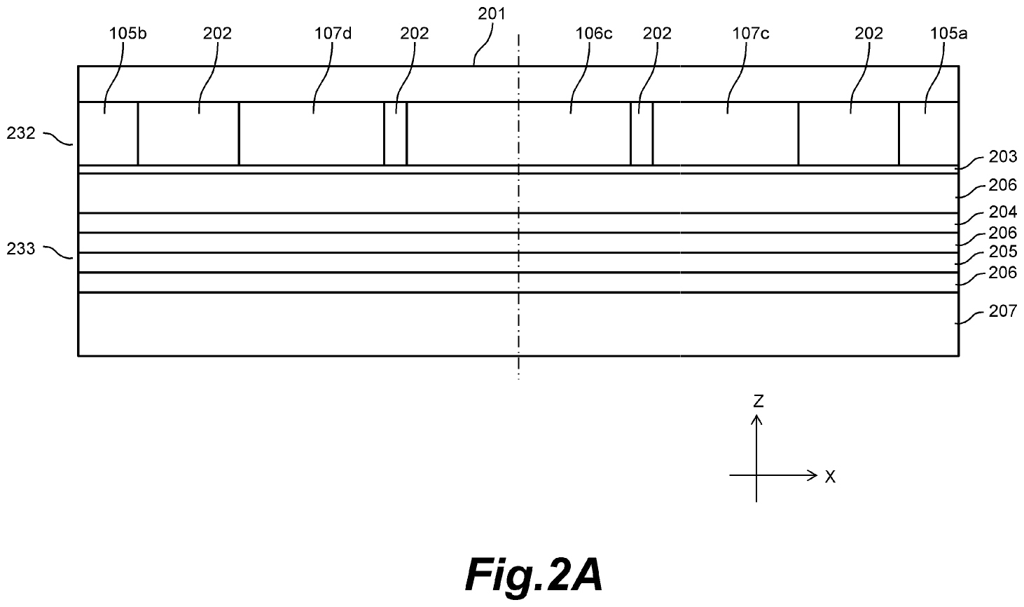

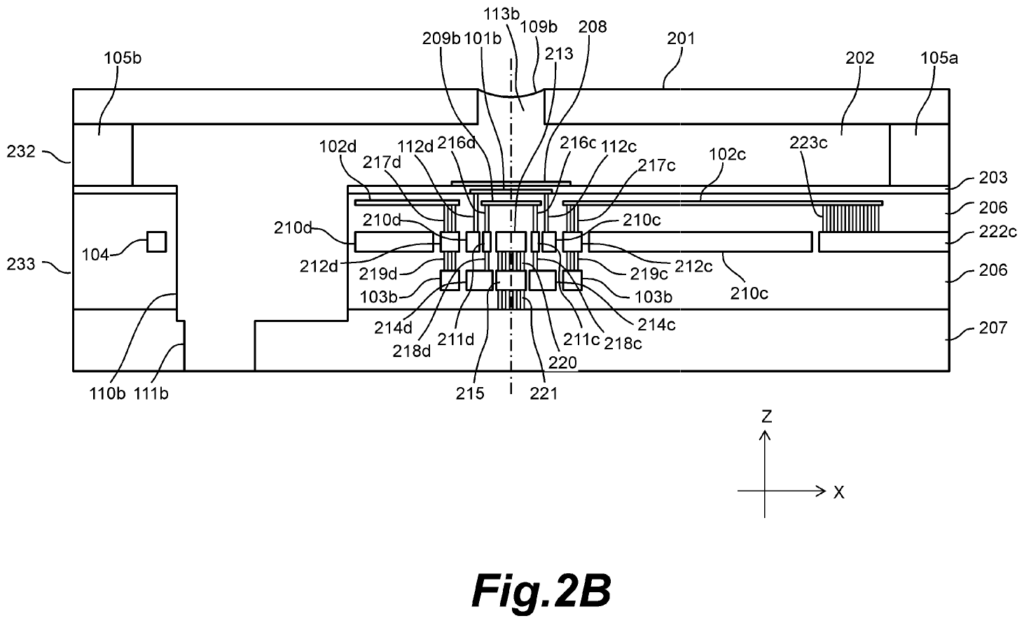

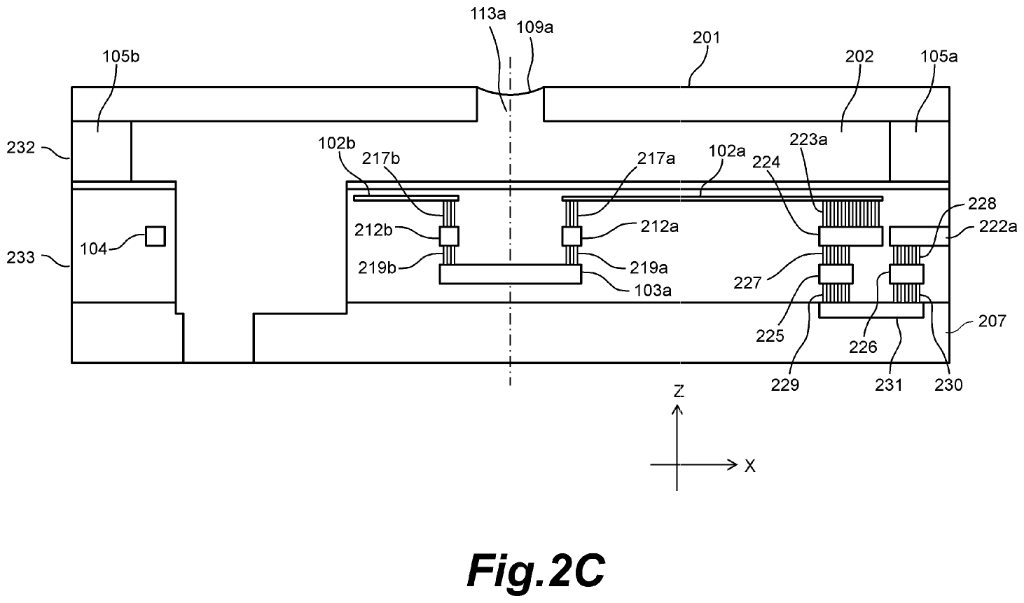

Embodiment 1 of the present invention will be described with reference to the drawings. FIG. 1 is a plan view depicting a part of the recording element substrate 1 according to Embodiment 1. FIG. 1 is a plan view when the recording head 2 is viewed from the substrate side in the ink discharging direction and indicates a portion that includes two nozzles out of a plurality of nozzles disposed on the recording element substrate 1. FIGS. 2A to 2C are cross-sectional views of the nozzles in FIG. 1, where FIG. 2A is an A-A cross-sectional view, FIG. 2B is a B-B cross-sectional view, and FIG. 2C is a C-C cross-sectional view. The structure of the nozzles and the vicinity thereof in Embodiment 1 will be described with reference to FIG. 1 and FIGS. 2A to 2C.

On the recording element substrate 1 which discharges liquid, inter-nozzle array partition walls 105a and 105b, to separate the nozzle arrays, are formed, and an orifice plate 201 is formed on the inter-nozzle array partition walls 105a and 105b. The region enclosed by the recording element substrate 1, the inter-nozzle array partition walls 105a and 105b and the orifice plate 201 becomes an ink passage 202 in the nozzle array.

The ink passage 202 is partitioned by inter-nozzle partition walls 106a, 106b and 106c, and foaming chambers 108a and 108b are formed between the inter-nozzle partition walls 106a, 106b and 106c. In FIG. 1, nozzles 113a and 113b, to which discharging ports 109a and 109b are connected respectively, are formed on the orifice plate 201, at each center of the foaming chambers 108a and 108b. On the surface of the recording element substrate 1, the plurality of discharging ports 109a and 109b are disposed side-by-side in a predetermined array direction (Y direction in FIG. 1), so as to form a discharging port array 1090. The plurality of nozzles 113a and 113b extend in the direction intersecting with the surface of the recording element substrate 1 (direction vertical to the front surface in Embodiment 1, that is, the Z direction in FIGS. 2A to 2C), and are connected to the plurality of discharging ports 109a and 109b. The plurality of foaming chambers 108a and 108b are a plurality of individual passages connected to the plurality of nozzles 113a and 113b respectively, and extend in the direction along the front surface of the recording element substrate 1 (direction parallel with the front surface in Embodiment 1, that is, the X direction in FIG. 1). The ink passage 202 is a common passage connected to the foaming chambers 108a and 108b which are a plurality of individual passages, and extends in the direction along the front surface of the recording element substrate 1 (direction parallel with the front surface in Embodiment 1, that is, the Y direction in FIG. 1). The layer where the foaming chambers 108a and 108b, which are individual passages, and the ink passage 202, which is a common passage, are formed, is a passage forming portion 232.

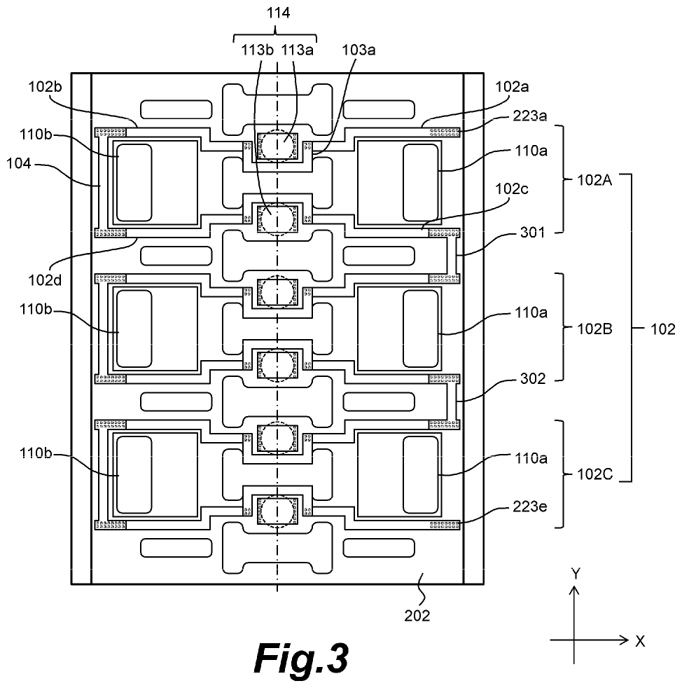

The ink passage 202, excluding the forming chambers 108a and 108b, is partitioned for each two nozzles by inter-ink supply port partition walls 107a and 107c, and inter ink supply port partition walls 107b and 107d. On the bottom surface of the ink passage 202, between the inter-ink supply port partition walls 107a and 107c and between the inter-ink supply port partition walls 107b and 107d, a first step of ink supply ports 110a and 110b (rectangular shape in the plan view) are engraved to be symmetrical with respect to the nozzle array. In Embodiment 1, the plurality of nozzles 113 of the recording element substrate 1 are divided into a plurality of nozzle groups 114, each of which is constituted of one or a plurality of nozzles, as indicated in FIG. 3, which will be referred to in a later mentioned modification of Embodiment 1. In Embodiment 1, one nozzle group 114 is constituted of two nozzles 113a and 113b, which are adjacent to each other. FIG. 1 indicates the nozzles 113a and 113b included in one nozzle group 114. A plurality of ink supply ports 110a are disposed at positions corresponding to the plurality of nozzle groups 114 respectively in the ink passage 202, which is a common passage. On the recording element substrate 1, the plurality of nozzle groups 114 are arrayed along the array direction of the nozzles (Y direction in FIG. 3). In FIG. 3, six nozzles 113 are divided into three nozzle groups 114, each of which includes two nozzles 113, respectively.

In the ink supply ports 110a and 110b, supply passages 111a and 111b are formed, of which passage cross-sections are smaller than those of the ink supply ports 110a and 110b, and which penetrate to the rear surface of the recording element substrate 1. The supply passages 111a and 111b extend in a direction intersecting with the rear surface of the recording element substrate 1 (direction vertical to the rear surface in Embodiment 1, that is, the Z direction in FIGS. 2A to 2C).

In the plan view, the ink supply ports 110a and 110b are larger than the supply passages 111a and 111b, respectively. Thereby the pressure loss, generated until the ink that flows from the ink supply ports 110a and 110b into the ink passages 202 reaches the foaming chambers 108a and 108b, can be reduced.

By the structure of the ink passage 202 described above, the ink, refilled from the two supply passages 111a and 111b, flows into the two foaming chambers 108a and 108b via the ink supply ports 110a and 110b.

In the recording element substrate 1 immediately below the discharging ports 109a and 109b, rectangular-shaped heaters 101a and 101b, constituted of a thin film resistor made of a thermally stable material with high resistivity (e.g., TaSiN), are disposed respectively. The heaters 101a and 101b are an example of discharging actuators, which apply energy to ink for discharging ink from the plurality of discharging ports 109a and 109b. The heaters 101a and 101b, which are also discharging heaters, are disposed in the foaming chambers 108a and 108b as well, which are individual passages.

The recording element substrate 1 is configured such that a plurality of wiring layers 204 and 205 are disposed on an insulating member 206 on a substrate 207. The recording element substrate 1 is configured such that a wiring portion 233, constituted of a plurality of inter-layer insulation film (insulator layers) made of insulating member 206 and the plurality of wiring layers 204 and 205 are layered, is disposed between the passage forming portion 232 and the rear surface of the substrate 207. Each of the wiring layers 204 and 205 is disposed between the insulating members 206. A semiconductor material, such as silicon, is used for the substrate 207, and an insulating material, such as silicon oxide, is used for the insulating member 206.

In FIG. 2B, a temperature sensor 209b, constituted of a thin film resistor, is disposed in the lower layer of the heater 101b via the insulating member 206. The temperature sensor 209b preferably is made of a material having a high resistivity, which is equivalent to that of the heater 101b, and has a high resistance temperature coefficient in order to increase the output voltage.

As indicated in the plan view in FIG. 1, in the wiring portion 233, sub-heaters 102a and 102c, configured to heat ink flowing through the ink passage 202, are disposed on the same layer as the temperature sensor 209b, along at least a part of the peripheral edge of the ink supply port 110a.

In Embodiment 1, the sub-heaters 102a and 102c are disposed along portions of the peripheral edge of the ink supply port 110a, which extend in the direction from the ink supply port 110a to the foaming chambers 108a and 108b, which are individual passages. Specifically, the sub-heaters 102a and 102c are disposed so as to sandwich the ink supply port 110a along the lateral side edges 1101 and 1102 of the peripheral edge of the ink supply port 110a in the array direction of the nozzles 113a and 113b (Y direction in FIG. 1).

Here in Embodiment 1, the peripheral edge of the ink supply port 110a has a rectangular shape constituted of a front side edge 1103, a rear side edge 1104, and the two lateral side edges 1101 and 1102. The front side edge 1103 is an edge extending in a direction along the array direction of the plurality of nozzles 113 (Y direction in FIG. 1), out of the edges constituting the peripheral edge of the ink supply port 110a, and is an edge located on a side closer to the foaming chambers 108a and 108b, which are individual passages. The rear side edge 1104 is an edge located on the opposite side of the front side edge 1103, out of the edges constituting the peripheral edge of the ink supply port 110a. In other words, the rear side edge 1104 is an edge extending in a direction along the array direction of the plurality of nozzles 113 (Y direction in FIG. 1), and is an edge located on the side closer to the inter-nozzle array partition wall 105a. The lateral side edges 1101 and 1102 are edges extending in a direction intersecting with the array direction of the plurality of nozzles 113 (Y direction in FIG. 1), that is, extending in a direction vertical to the array direction in Embodiment 1 (X direction in FIG. 1), out of the edges constituting the peripheral edge of the ink supply port 110a.

In Embodiment 1, the foaming chambers (individual passages), the ink passage (common passage), the ink supply port, the supply passages and sub-heaters are disposed on each side of the nozzle array constituted of the plurality of nozzles 113 (on each side thereof in the X direction in FIG. 1), to be symmetric with respect to the nozzle array. Sub-heaters 102b and 102d are also disposed along the lateral sides of the ink supply port 110b in the same manner.

On the heater 101b, a protective film 203, made of an insulator, such as SiN, is formed. On this protective film 203, a cavitation resistant film 208 made of Ta or the like is formed at a position corresponding to the heater 101b, which is a discharging actuator, so as to cover the region where the heater 101b is disposed.

The above-mentioned heater 101b, the temperature sensor 209b and the sub-heaters 102a to 102d are electrically connected via the wiring patterns and conductive plugs formed on the plurality of wiring layers, whereby a circuit is formed. In Embodiment 1, the first wiring layer 205 which is closest to the substrate 207, and the second wiring layer 204 which is above the first wiring layer 205 (a total of two wiring layers) are disposed.

In FIG. 2B, the heater 101b is connected to a wiring pattern 210c of the second wiring layer 204 via a conductive plug 112c at one end in a vertical direction (X direction) to the nozzle array direction (Y direction). The heater 101b is also connected to a wiring pattern 210d of the second wiring layer 204 via a conductive plug 112d at the other end. In Embodiment 1, the shape of the heater 101a is rectangular, of which long sides are the edges of both ends in the nozzle array direction (Y direction), and the short sides are the edges of both ends in the vertical direction (X direction) to the nozzle array direction. This means that the conductive plugs 112c and 112d are disposed on both ends of the short sides of the heater 101b, respectively. Here it is assumed that the wiring pattern 210c is connected to the power supply line, and the wiring pattern 210d is grounded via a switch element (not illustrated). The shape of the heater 101a here is an example, and the present invention is not limited thereto.

The temperature sensor 209b is connected to a pad 211c of the second wiring layer 204 via a conductive plug 216c disposed on one end, and is connected to a wiring pattern 214c of the first wiring layer 205 via a conductive plug 218c. A conductive plug 216d disposed on the other end is connected to a pad 211d in the same manner, and is connected to a wiring pattern 214d of the first wiring layer 205 via a conductive plug 218d.

Below the heater 101b, a heat dissipation pattern 213 is disposed on the second wiring layer 204, the heat dissipation pattern 213 is connected to a heat dissipation pattern 215 of the first wiring layer 205 via a plug 220, and the heat dissipation pattern 215 is connected to the substrate 207 via a plug 221. By this configuration, in a case where the heater 101b is driven and heated and this driving is then suppressed, this heat is quickly released to the substrate 207.

The temperature sensor, the heat dissipation pattern, and the wiring structure thereof below the heater 101a are the same as those below the heater 101b, hence description thereof will be omitted.

In FIG. 2C, the sub-heater 102a is connected to a pad 224 via a conductive plug 223a disposed on one end, and is then connected to a switch element 231 formed on the substrate 207 via a conductive plug 227, a pad 225 and a conductive plug 229. The switch element 231 is connected to a wiring pattern 222a via a conductive plug 230, a pad 226 and a conductive plug 228, and the wiring pattern 222a is connected to a power supply line (not illustrated). By this configuration, when the switch element 231 is ON, the sub-heater 102a and the wiring pattern 222a conduct, and a predetermined voltage is applied to the sub-heater 102a.

The other end of the sub-heater 102a is connected to a wiring pattern 103a via a conductive plug 217a, a pad 212a and a conductive plug 219a. In the same manner, one end of the sub-heater 102b is also connected to the wiring pattern 103a via a conductive plug 217b, a pad 212b and the conductive plug 219b. Thereby the sub-heater 102a and 102b are connected in series via the wiring pattern 103a. In other words, in Embodiment 1, the two sub-heaters 102a and 102b, located at symmetric positions with respect to the nozzle array, are electrically connected.

In order to prevent interference with the wiring structure below the heater 101a, the wiring pattern 103a is disposed in a U shape, so as to bypass a region to which the heater 101a is projected in the discharging direction (direction vertical to the front surface of the recording element substrate 1), as illustrated in FIG. 1.

The sub-heaters 102c and 102d also have the same configuration as the sub-heaters 102a and 102b. In other words, the other end of the sub-heater 102c is connected to a wiring pattern 103b via a conductive plug 217c, a pad 212a, and a conductive plug 219c. One end of the sub-heater 102d is connected to the wiring pattern 103b via a conductive plug 217d, a pad 212d and a conductive plug 219d. Just like the wiring pattern 103a, the wiring pattern 103b (see FIG. 2B) is also disposed in a U shape, so as to bypass a region to which the heater 101b is projected in the discharging direction. This means that the two sub-heaters 102c and 102d, located at symmetric positions with respect to the nozzle array, are also electrically connected.

The other end of the sub-heater 102b is connected to one end of the sub-heater 102d via a conductive plug 223b, a wiring pattern 104 of the second wiring layer 204, and a conductive plug 223d. The sub-heater 102c is connected to a wiring pattern 222c via a conductive plug 223c, and the wiring pattern 222c is grounded to a ground line (not illustrated). In other words, in Embodiment 1, the two sub-heaters 102b and 102d, disposed adjacent to each other in the array direction (Y direction) of the plurality of nozzles 113 in the nozzle array, are electrically connected.

Because of the above configuration, when a switch element 231 is ON, a predetermined voltage is applied between the conductive plugs 223a and 223c, which are both end terminals of the sub-heater group where the sub-heaters 102a, 102b, 102d and 102c are connected in series in this order, and heating is started simultaneously.

At a non-printing time (when image recording is not performed), where the driving voltage is not applied to the heaters 101a and 101b, the control unit 300 performs control to circulate the ink. Specifically, the control unit 300 controls such that ink is supplied from the ink supply port 110a at a low flow rate for ink circulation to prevent drying of the nozzles, and is collected from the ink supply port 110b via the foaming chambers 108a and 108b.

At this time, the control unit 300 performs the PWM control for the switch element 231, so that the ink temperature of ink flowing directly under the discharging ports 109a and 109b becomes a predetermined target temperature for circulation, whereby the sub-heaters 102a to 102d are controlled in the low heating mode. The target temperature for circulation is set so that the pre-heating appropriate for ink circulation is performed on the ink that flows into the foaming chambers 108a and 108b.

At printing time (when image recording is performed), where driving voltage is applied to the heaters 101a and 101b, the control unit 300 performs control to refill the ink. Specifically, the control unit 300 controls such that ink is refilled from the ink supply ports 110a and 110b on both sides of the nozzle array, and flows into the foaming chambers 108a and 108b respectively. The flow rate of the ink for refilling is higher than the flow rate of the ink for circulation.

At this time, the control unit 300 performs the PWM control for the switch element 231, so that the ink temperature of ink which reached directly under the discharging ports 109a and 109b becomes a predetermined target temperature for refilling, whereby the sub-heaters 102a to 102d are controlled in the high heating mode. The target temperature for refilling is set so that a preheating appropriate for printing is performed on the ink that flows into the foaming chambers 108a and 108b.

In this way, the control unit 300 may control the sub-heaters 102a to 102d such that the heat value of the sub-heaters 102a to 102d, in a case of performing the image recording, is higher than the heat value of the sub-heaters 102a to 102d in the case of not performing the image recording.

As indicated by the solid-lined arrow marks in FIG. 1, the ink refilled from the lateral sides of the ink supply port 110a passes above the sub-heater 102c along the sub-heater 102c, therefore the ink is heated for a long time. Hence the degree of increase in the ink temperature near the sub-heater 102c is high, and the heat is transferred to the ink that flows at a position near the upper surface of the ink passage 202, that is, the temperature of the ink in the height direction of the ink passage 202 does not disperse very much.

The ink refilled from the front side of the ink supply port 110a, on the other hand, only passes a part of the upper portion of the sub-heater 102c, as indicated by the broken-lined arrow marks in FIG. 1, therefore the ink is heated for a short time. Hence the degree of increase in the ink temperature near the sub-heater 102c is low, and the heat is not sufficiently transferred to the ink that flow at a position near the upper surface of the ink passage 202, that is, the temperature of the ink in the height direction of the ink passage 202 tends to easily disperse.

Since each ink of which heating time by the sub-heater 102c is different mixes with each other and flows into the foaming chamber 108b, the temperature of the ink to be refilled becomes more uniform compared with the configuration of heating only the ink in the passage from the front side of the ink supply port 110a. The way of flowing the refill ink and the way of heating the ink by the sub-heater are also the same for the refill ink that flows into the foaming chamber 108a.

Thus according to Embodiment 1, the refill ink that flows from the ink supply port 110a into the ink passage 202 is heated by the sub-heaters 102a and 102c, and flows into the foaming chambers 108a and 108b in the state where the temperature has uniformly risen. Hence the discharge amount fluctuation and discharge failure, due to an increase in viscosity of the ink, can be suppressed.

Modification

FIG. 3 is a plan view depicting a part of a recording element substrate of a modification of Embodiment 1. FIG. 3 is a plan view when the recording head 2 is viewed from the substrate side in the ink discharging direction, and indicates a portion including six nozzles out of a plurality of nozzles disposed on the recording element substrate 1. In the modification, a sub-heater group is constituted of four sub-heaters 102a, 102b, 102d and 102c of Embodiment 1 connected in series, and three of these sub-heater groups are connected in series in the nozzle array direction, as one sub-heater group 102.

In FIG. 3, three sub-heater groups 102A, 102B and 102C are connected in series by two wiring patterns 301 and 302 of the second wiring layer 204, and function as one sub-heater group 102 to heat ink for the six nozzles.

When the switch element 231 (see FIG. 2C) is turned ON, a predetermined voltage is applied between the conductive plugs 223a and 223e, which become both terminals of the sub-heater group 102, and heating starts at the same time.

For example, to control the heating value of the sub-heater group 102, the heating value may be controlled in accordance with a nozzle of which ink discharging frequency is highest among the six nozzles. The method for controlling the heating value, however, is not limited to this example. Compared with a case of disposing the switch element 231 for each sub-heater group constituted of four sub-heaters 102a, 102b, 102d and 102c, as in the configuration in FIG. 1, a total number of switch elements can be ⅓ in this modification, and the total number of sub-heaters which are targets of the heating control can also be ⅓. Therefore, the heating control for the sub-heater groups can be simplified.

### Embodiment 2

Embodiment 2 of the present invention will be described. A composing element the same as Embodiment 1 will be denoted with a same reference sign and name, and detailed description thereof will be omitted.

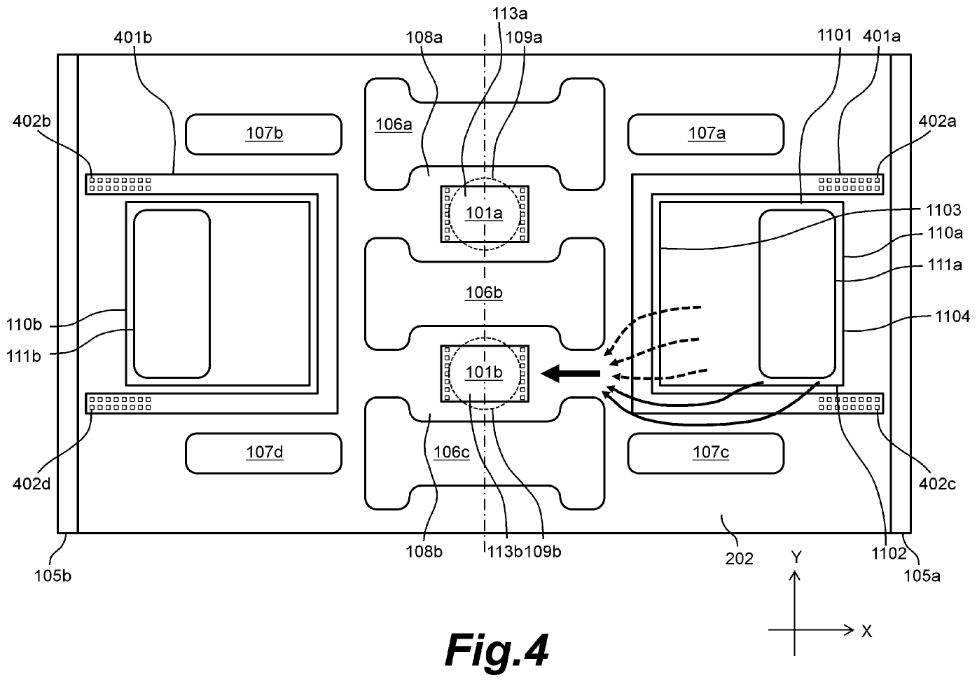

FIG. 4 is a plan view depicting a part of the recording element substrate 1 according to Embodiment 2. FIG. 4 is a plan view when the recording head 2 is viewed from the substrate side in the ink discharging direction, and indicates a portion including two nozzles out of a plurality of nozzles disposed on the recording element substrate 1. In Embodiment 2, each sub-heater is disposed in a U shape on the same layer as the temperature sensor installed on the recording element substrate 1, so as to surround the front side and both lateral sides of the ink supply port.

In a case where the height of the ink passage 202 is relatively high, a flow of the ink stagnates behind the ink supply port 110a. Therefore, when refilled, ink flows into the ink passage 202 from the ink supply port 110a mainly from the front side and lateral sides.

In Embodiment 2, as illustrated in FIG. 4, a sub-heater 401a is disposed in a U shape, so as to surround the front side and lateral sides of the ink supply port 110a. Specifically, each of the sub-heaters 401a and 401c is disposed along the lateral side edges 1101 and 1102 and the front side edge 1103 out of the peripheral edges of the ink supply port 110a, so as to surround the ink supply port 110a in a U shape.

One end of the sub-heater 401a is connected to a switch element (not illustrated) via a conductive plug 402a, and the switch element is connected to a power supply line (not illustrated) via a wiring pattern of the second wiring layer 204. The other end of the sub-heater 401a is connected to the wiring pattern (not illustrated) of the second wiring layer 204 via a conductive plug 402c, and this wiring pattern is ground to a ground line (not illustrated). These configurations are the same as those of the sub-heaters 102a and 102c in Embodiment 1.

As indicated by the broken-lined arrow marks in FIG. 4, according to the configuration of the sub-heater 401a of Embodiment 2, the ink that flows from the front side of the ink supply port 110a into the ink passage 202 can be heated by the sub-heater 401a.

The relationship between a sub-heater 401b and the ink supply port 110b is the same as the relationship between the sub-heater 401a and the ink supply port 110a. The configuration of the sub-heater 401b and conductive plugs 402b and 402d are the same as the configuration of the sub-heater 401a and the conductive plugs 402a and 402c.

In Embodiment 2, the control unit 300 may be able to individually control the heating by the sub-heaters 401a and 401b. Here in the case of performing image recording, it may be controlled to heat both of the sub-heaters 401a and 401b disposed on each side of the nozzle array by allowing ink to flow into the ink passage 202 from both the ink supply ports 110a and 110b disposed on each side of the nozzle array. In the case of not performing image recording, it may be controlled to circulate the ink by allowing ink to flow into the ink passage 202 from one ink supply port 110a, and allowing ink to flow from the other ink supply port 110b, and to heat only the sub-heater 401a, which is disposed on the peripheral edge of the ink supply port 110a used for allowing ink to flow in.

Thus according to the configuration of Embodiment 2, the ink refilled from the ink supply ports 110a and 110b can be sufficiently heated before flowing into the foaming chambers 108a and 108b. Therefore, heat transfer and stirring in the ink can be sufficiently performed, and the temperature of the ink that flows into the foaming chambers 108a and 108b can rise more uniformly. Hence the discharge amount fluctuation and discharge failure due to an increase in viscosity of the ink can be suppressed with more certainty.

### Embodiment 3

Embodiment 3 of the present invention will be described. A composing element the same as Embodiment 1 will be denoted with a same reference sign and name as Embodiment 1, and detailed description thereof will be omitted.

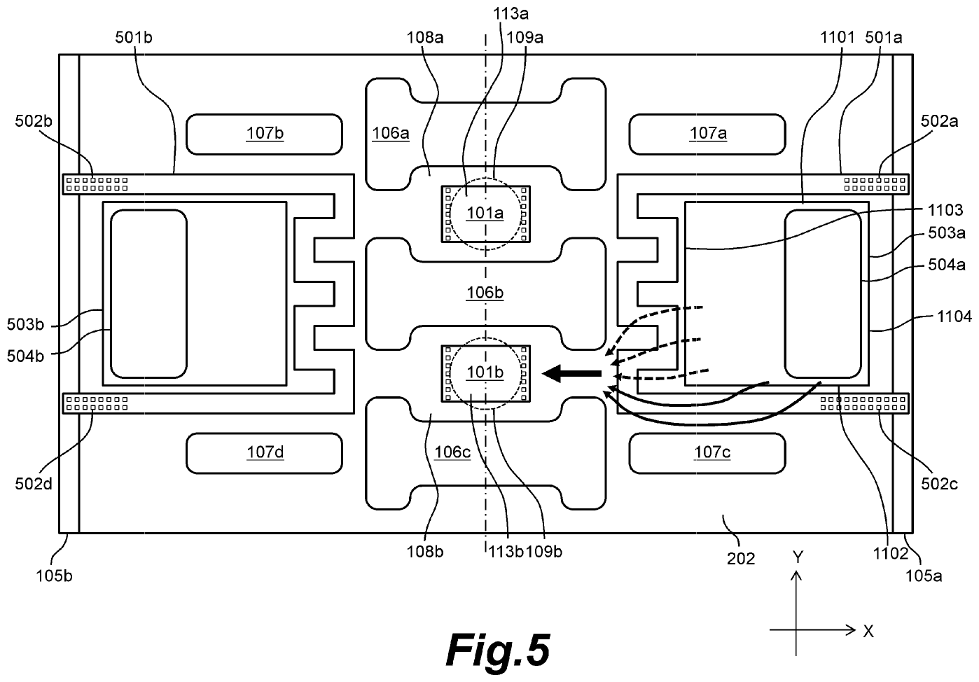

FIG. 5 is a plan view depicting a part of the recording element substrate 1 according to Embodiment 3. FIG. 5 is a plan view when the recording head 2 is viewed from the substrate side in the ink discharging direction, and indicates a portion including two nozzles out of a plurality of nozzles disposed on the recording element substrate 1. In Embodiment 3, each sub-heater is disposed in a U shape on the same layer as the temperature sensor installed on the recording element substrate 1, so as to surround the front side and both lateral sides of the ink supply port, and particularly the portion of the sub-heater disposed on the front side of the ink supply port is folded back a plurality of times to create a waveform.

In FIG. 5, ink supply ports 503a and 503b are disposed more distant from the center of the nozzle array, compared with the ink supply ports 110a and 110b indicated in FIG. 1. Therefore, the spaces between the ink supply ports 503a and 503b and the inter-nozzle partition walls 106a, 106b and 106c are wide. Using these spaces, the shape of each sub-heater can be designed to increase the area of the sub-heater.

In Embodiment 3, as illustrated in FIG. 5, a sub-heater 501a is disposed in a U shape, so as to surround the front side and the lateral sides of the ink supply port 503a, just like the sub-heater 401a of Embodiment 2. Specifically, the sub-heater 501a is disposed along the lateral side edges 1101 and 1102 and the front side edge 1103 out of the peripheral edge of the ink supply port 503a, so as to surround the ink supply port 503a in a U shape. Furthermore, a part of the sub-heater 501a disposed along the front side edge 1103 of the ink supply port 503a is folded back a plurality of times to create a waveform. Thereby the area of the portion of the sub-heater 501a disposed on the front side of the ink supply port 503a increases.

One end of the sub-heater 501a is connected to a switch element (not illustrated) via a conductive plug 502a, and the switch element is connected to a power supply line (not illustrated) via a wiring pattern of the second wiring layer 204. The other end of the sub-heater 501a is connected to the wiring pattern (not illustrated) of the second wiring layer 204 via a conductive plug 502c, and this wiring pattern is grounded to a ground line (not illustrated). These configurations are the same as those of the sub-heater 401a of Embodiment 2.

The relationship between ink supply ports 504a and 504b and the ink supply ports 503a and 503b is the same as the relationship between the supply passages 111a and 111b and the ink supply ports 110a and 110b of Embodiment 1.

Just like the configuration of the sub-heater 501a, the portion of the sub-heater 501b disposed on the front side of the ink supply port 503b is also folded back a plurality of times to create a waveform. The configuration of the sub-heater 501b and the conductive plugs 502b and 502d is also the same as the configuration of the sub-heater 501a and the conductive plugs 502a and 502c.

Thereby, as indicated by the broken-lined arrow marks in FIG. 5, a larger amount of ink refilled from the front side of the ink supply port 503a can be heated for a longer time by the sub-heater 501a. Therefore, the temperature different from the ink refilled from the lateral sides of the ink supply port 503a, as indicated by the solid-lined arrow marks, decreases, and the temperature of the ink that flows into the foaming chambers 108a and 108b can be uniformly increased. Hence the discharge amount fluctuation and discharge failure due to an increase in viscosity of the ink can be suppressed with more certainty.

### Embodiment 4

Embodiment 4 of the present invention will be described. A composing element the same as Embodiment 1 will be denoted with a same reference sign and name, and detailed description thereof will be omitted.

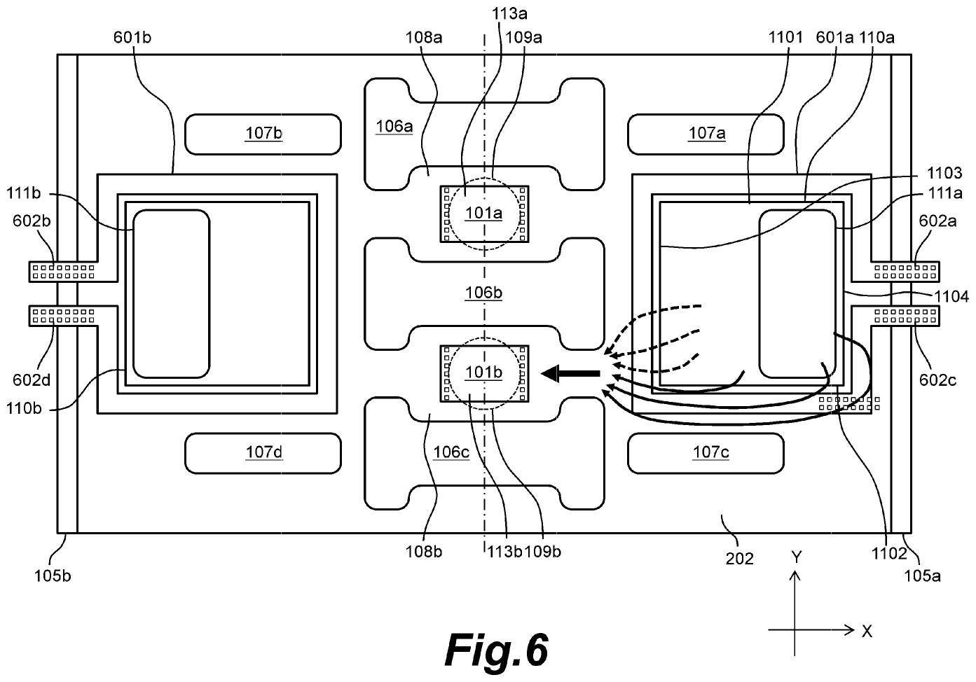

FIG. 6 is a plan view depicting a part of the recording element substrate 1 according to Embodiment 4. FIG. 6 is a plan view when the recording head 2 is viewed from the substrate side in the ink discharging direction, and indicates a portion including two nozzles out of a plurality of nozzles disposed on the recording element substrate 1. In Embodiment 4, each sub-heater is disposed in an Ω shape on the same layer as the temperature sensor installed on the recording element substrate 1, so as to entirely surround the ink supply port.

In a case where the height of the ink passage 202 is relatively low, ink flows behind the ink supply port 110a when refilled, as indicated by the solid-lined arrow marks in FIG. 6, and the flow of the ink does not stagnate very much in the rear side of the ink supply port 110a. The ink that flows behind the ink supply port 110a flows back into the front side of the ink supply port 110a along the inter-nozzle array partition wall 105a and the inter-ink supply port partition wall 107c, and flows into the foaming chambers 108a and 108b.

Therefore as illustrated in FIG. 6, a sub-heater 601a is disposed in an Ω shape so as to entirely surround the ink supply port 110a. Specifically, the sub-heater 601a is disposed along the lateral side edges 1101 and 1102, the front side edge 1103 and the rear side edge 1104, out of the peripheral edge of the ink supply port 110a, so as to entirely surround the ink supply port 110a in an Ω shape.

One end of the sub-heater 601a is connected to a switch element (not illustrated) via a conductive plug 602a, and the switch element is connected to a power supply line (not illustrated) via a wiring pattern of the second wiring layer 204. The other end of the sub-heater 601a is connected to the wiring pattern (not illustrated) of the second wiring layer 204 via a conductive plug 602c, and this wiring pattern is grounded to a ground line (not illustrated). These configurations are the same as the sub-heaters 102a and 102c in Embodiment 1.

According to the configuration of the sub-heater 601a of Embodiment 4, compared with the ink that flows from the front side or the lateral sides of the ink supply port 110a, the ink that flows from the rear side of the ink supply port 110a passes above the sub-heater 601a for a longer distance taking a longer heating time. Therefore, the temperature of the ink that flows from the rear side of the ink supply port 110a becomes higher than the temperature of the ink that flows from the front side or lateral sides of the ink supply port 110a, and the temperature distribution in the ink passage 202 in the highest direction becomes more uniform. Thus ink flows in from the rear side, lateral sides and front side of the ink supply port 110a, and each link of which heating time by the sub-heater 601a is different from each other, having a different temperature, and a different temperature distribution, merges at the entrance of the foaming chamber 108b, hence the temperature of the ink becomes more uniform.

The relationship between a sub-heater 601b and the ink supply port 110b is the same as the relationship between the sub-heater 601a and the ink supply port 110a. The configuration of the sub-heater 601b and the conductive plugs 602b and 602d is the same as the configuration of the sub-heater 601a and the conductive plugs 602a and 602c.

According to Embodiment 4, the ink refilled from the ink supply port 110a to the ink passage 202 is heated by the sub-heater 601a, and flows into the foaming chambers 108a and 108b in a uniformly heated state. Hence the discharge amount fluctuation and discharge failure due to an increase in viscosity of the ink can be suppressed with more certainty.

### Other Embodiments

Embodiments 1 to 4 have been described above, but the present invention is not limited thereto. For example, the shape of the ink supply port is not limited to a rectangle. For example, even if the shape of the ink supply port is a circle, the sub-heater may be disposed along at least a part of the peripheral edge of the ink supply port, whereby the same effect as each embodiment described above can be implemented. In this case, instead of the sub-heater disposed along the lateral side edges, front side edge and rear side edge of the rectangular ink supply port, a sub-heater may be disposed along the arcs of the lateral sides, front side and rear side of the ink supply port. In the wiring portion 233, the layer on which the sub-heater is installed is not limited to the same layer as the temperature sensor, but may be the same layer as the discharging heater or the cavitation resistant film. Further, the sub-heater may be disposed along the peripheral edge of each ink supply port included in an ink supply port array on one side, out of the ink supply port arrays disposed on both sides of the nozzle array. Further, the ink supply port array may be disposed only on one side of the nozzle array. The wiring layer is not limited to the two-layer configuration, but may be a three-layer or four-layer configuration, for example. A number of nozzles included in one nozzle group, corresponding to one link supply port, may be two or more. The discharging actuator to apply energy to the ink to discharge the ink droplets is not limited to the heater, but may be a piezoelectric element, for example.

According to the present invention, a recording element substrate and a recording device equipped with a sub-heater that can heat such liquid as ink more uniformly can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-184691, filed on Nov. 18, 2022, which is hereby incorporated by reference herein in its entirety.

What is claimed is:

1. A recording element substrate comprising:
a discharging port array which is disposed on a front surface of the recording element substrate, and includes a plurality of discharging ports arrayed in an array direction;
a plurality of nozzles which extend in a direction intersecting with the front surface of the recording element substrate, and are connected to the plurality of discharging ports respectively;
a passage forming portion in which a plurality of individual passages and a common passage are formed, the plurality of individual passages extending in a direction along the front surface of the recording element substrate and being connected to the plurality of nozzles respectively, and the common passage being connected to the plurality of individual passages;
a plurality of supply ports which are disposed on the common passage and are arrayed along the array direction, and are disposed such that, in a case where the plurality of nozzles are divided into a plurality of nozzle groups and each nozzle group includes one or a plurality of nozzles, the plurality of supply ports are disposed at positions corresponding to the plurality of nozzle groups on the common passage respectively; and
a plurality of supply passages which extend from the plurality of supply ports to a rear surface of the recording element substrate in a direction intersecting with the rear surface of the recording element substrate, wherein
a plurality of heaters configured to heat liquid flowing through the common passage are provided for each of the plurality of supply ports along at least a part of a peripheral edge of the supply port.

2. The recording element substrate according to claim 1, wherein
the heater is disposed along a portion of the peripheral edge of the supply port, the portion extending in a direction from the supply port to the individual passage.

3. The recording element substrate according to claim 1, wherein
the peripheral edge of the supply port has a rectangular shape constituted of:
a front side edge which extends in a direction along the array direction of the plurality of nozzles and is located on the side closer to the individual passage;
a rear side edge on the opposite side of the front side edge; and
two lateral side edges which extend in a direction intersecting with the array direction, from the supply port toward the individual passage, and
the heater is disposed along the lateral side edges of the peripheral edge of the supply port.

4. The recording element substrate according to claim 3, wherein
the heater is additionally disposed along the front side edge of the peripheral edge of the supply port.

5. The recording element substrate according to claim 4, wherein
the heater is additionally disposed along the rear side edge of the peripheral edge of the supply port.

6. The recording element substrate according to claim 4, wherein
the portion of the heater disposed along the front side edge is folded a plurality of times to create a waveform.

7. The recording element substrate according to claim 1, wherein
the plurality of individual passages, the common passage, the plurality of supply ports, the plurality of supply passages and the plurality of heaters are disposed on both sides of a nozzle array constituted of the plurality of nozzles.

8. The recording element substrate according to claim 1, wherein
the plurality of individual passages, the common passage, the plurality of supply ports, the plurality of supply passages and the plurality of heaters are disposed on both sides of a nozzle array constituted of the plurality of nozzles so as to be symmetric with respect to the nozzle array.

9. The recording element substrate according to claim 8, wherein
the two heaters at symmetric positions with respect to the nozzle array are electrically connected.

10. The recording element substrate according to claim 1, wherein
the two heaters adjacent to each other in the array direction are electrically connected.

11. The recording element substrate according to claim 1, wherein
the nozzle group is constituted of a plurality of nozzles adjacent to each other.

12. The recording element substrate according to claim 1, further comprising a plurality of discharging actuators configured to apply energy to liquid so as to discharge the liquid from the plurality of discharging ports respectively.

13. The recording element substrate according to claim 12, wherein
the discharging actuator is a discharging heater disposed on the individual passage.

14. The recording element substrate according to claim 13, further comprising:
a wiring portion which is disposed between the passage forming portion and the rear surface of the recording element substrate, and which is formed by layering at least an insulator layer and a wiring layer, wherein
the heater and the discharging heater are disposed on a same layer in the wiring portion.

15. The recording element substrate according to claim 13, further comprising:
a wiring portion which is disposed between the passage forming portion and the rear surface of the recording element substrate, and which is formed by layering at least an insulator layer and a wiring layer; and
a temperature sensor which is disposed on a lower layer than the discharging heater in the wiring portion, wherein
the heater and the temperature sensor are disposed on a same layer in the wiring portion.

16. The recording element substrate according to claim 12, further comprising:
a cavitation resistant film which is disposed at a position corresponding to the discharging actuator in the individual passage, wherein
the heater is disposed on a same layer as the cavitation resistant film.

17. A recording device comprising:
a liquid discharging head including the recording element substrate according to claim 1; and
a control unit configured to control the heater, wherein
image recording is performed on a recording medium using ink, which is liquid discharged from the liquid discharging head.

18. The recording device according to claim 17, wherein
the control unit controls the heater such that a heating value of the heater in the case of performing image recording becomes larger than a heating value of the heater in the case of not performing the image recording.

19. The recording device according to claim 17, wherein
the plurality of individual passages, the common passage, the plurality of supply ports, the plurality of supply passages and the plurality of heaters are disposed on both sides of a nozzle array constituted of the plurality of nozzles, wherein
in the case of performing image recording, the control unit allows the liquid flow into the common passage from both of the supply ports disposed on each side of the nozzle array and heat both of the heaters disposed on each side of the nozzle array, and
in the case of not performing image recording, the control unit circulates the liquid by allowing the liquid flow into the common passage from one of the supply ports disposed on each side of the nozzle array and allowing the liquid of the common passage to flow out of the other supply port, and heats a heater corresponding to the supply port from which the liquid flows into the common passage, among the heaters disposed on each side of the nozzle array.
